(19) United States
(12) Patent Application Publication
(10) Pub. No.: US 2026/0063920 A1
(43) Pub. Date: Mar. 5, 2026

(54) DUAL PRISM OPTICAL IMAGE STABILIZATION

(71) Applicant: Google LLC, Mountain View, CA (US)

(72) Inventors: Hyuk Jae Choi, Pleasanton, CA (US); Dansik Yoo, Sunnyvale, CA (US); Zhenhong Fu, San Jose, CA (US); Calvin Kyaw Wong, Cupertino, CA (US); Aram Afshar, Newark, CA (US)

(21) Appl. No.: 18/817,789

(22) Filed: Aug. 28, 2024

(51) Int. Cl. G02B 27/64; G02B 13/00; G03B 5/00; H04N 23/68

(52) U.S. Cl. CPC G02B 27/646; G02B 13/0065; G03B 5/00; H04N 23/686; G03B 2205/0007

(57) ABSTRACT

A camera includes an image sensor, a lens configured to focus light to the image sensor, a first prism, a first actuator configured to rotate the first prism about a first axis, a second prism, and a second actuator configured to rotate the second prism about a second axis substantially perpendicular to the first axis. The camera also includes a controller configured to perform optical image stabilization (OIS) by independently controlling the first actuator to rotate the first prism about the first axis and controlling the second actuator to rotate the second prism about the second axis.

### BACKGROUND

Existing optical systems of cameras in electronic products include optical image stabilization via rotation of a single prism about two axes. However, optical image stabilization with a single prism may result in cross-talk between the two axes.

### SUMMARY

In general, aspects of this disclosure are directed to techniques, systems, and lenses having an optical image stabilization (OIS). Example lens designs include one or more lens elements (e.g., having optical power) and at least two prism elements (e.g., for controlling, redirecting, and/or folding the optical path of the lens/imaging system). The first prism is rotatable about a first rotational axis and the second prism is rotatable about a second rotation axis that is substantially perpendicular to the first rotational axis. The first and second prisms are rotatable independent of each other, and are configured to scan an image (e.g., formed by an optical system including the first and second prisms) in perpendicular, or orthogonal, directions without cross-talk between the two perpendicular directions.

The techniques, systems, and lenses of this disclosure may provide one or more technical advantages and solve one or more technical problems. For example, the techniques, systems, and lenses provide independent control of perpendicular scanning directions for OIS without cross-talk between the two perpendicular directions. Such independent control provides less complex, faster, and more accurate determination of scanning amounts, and less complex, faster, and more accurate OIS, e.g., scanning by the lens system (e.g., the two separate prisms). The techniques, systems, and lenses may also provide a larger useable sensor area for image capture. For example, less of the area of the sensor needs to be reserved as a border region for capturing an image that is rotated relative to the first and second scan directions due to cross-talk. Additionally, the techniques, systems, and lenses may provide a longer total track length (TTL) for a camera lens. For example, using two independently rotatable prism, rather than a single prism, may allow the optical axis of the system to be folded in multiple directions providing additional freedom to position the sensor of the system, which provides freedom to increase the effective focal length (EFL) of the lens system, e.g., for a telephoto camera lens system.

In some aspects, the aspects described herein relate to a camera including: an image sensor; a lens configured to focus light to the image sensor; a first prism; a first actuator configured to rotate the first prism about a first axis; a second prism; a second actuator configured to rotate the second prism about a second axis substantially perpendicular to the first axis; and a controller configured to perform optical image stabilization (OIS) by independently controlling the first actuator to rotate the first prism about the first axis and controlling the second actuator to rotate the second prism about the second axis.

In some aspects, the aspects described herein relate to an optical system including: a lens defining an optical axis; a first prism configured to rotate about a first axis; and a second prism configured to rotate about a second axis substantially perpendicular to the first axis.

In some aspects, the aspects described herein relate to a method including: capturing, by an image sensor, an image; performing optical image stabilization (OIS) by: rotating, by a first actuator, a first prism of a camera about a first axis to scan an image in a first direction; and rotating, by a second actuator, a second prism of the camera about a second axis substantially perpendicular to the first axis to scan the image in a second direction independently from and substantially perpendicular to the first direction.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a schematic perspective view of an example camera including dual prisms, in accordance with one or more aspects of the present disclosure.

FIG. 2 is a set of example image positions during an optical image stabilization (OIS) scan illustrating cross-talk between the scan axes of a single prism optical image stabilization lens.

FIG. 3 is a set of example image positions during an optical image stabilization (OIS) scan illustrating no cross-talk between the scan axes of a dual prism OIS lens, in accordance with one or more aspects of the present disclosure.

FIG. 4 is an example computer system that may be used with the example camera of FIG. 1, in accordance with one or more aspects of the present disclosure.

FIG. 5 is a flow chart of an example method of optical image stabilization using a dual prism lens, in accordance with one or more aspects of the present disclosure.

### DETAILED DESCRIPTION

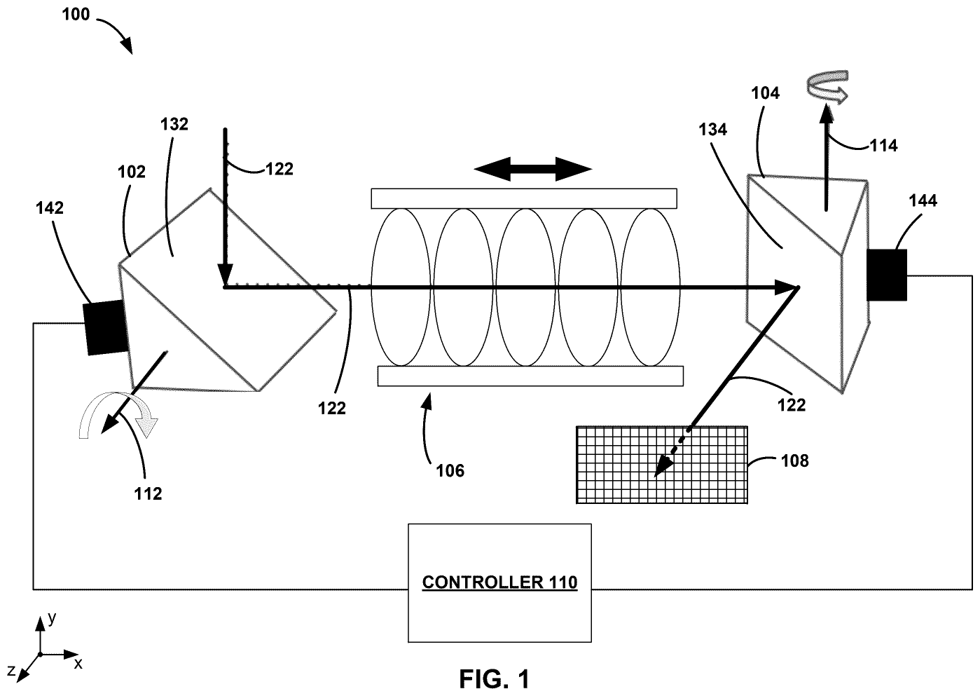

FIG. 1 is a schematic perspective view of an example camera 100 including dual prisms 102, 104, in accordance with one or more aspects of the present disclosure. In the example shown, camera 100 includes first prism 102, lens 106, second prism 104, sensor 108, first and second actuators 142, 144, and controller 110. Sensor 108 may be an image sensor, and may comprise an array of light sensitive pixels and/or detectors, e.g., focal plane array.

First prism 102, lens 106, and second prism 104 may be arranged along optical axis 122. Optical axis 122 may be an axis of symmetry of camera 100 and/or an optical system including first and second prisms 102, 104. For example, first and second prisms 102, 104 and lens 106 may comprise components of a rotationally symmetric multi-element lens of camera 100, where optical axis 122 is the axis of rotational symmetry. First and second prisms 102, 104 may each be configured to fold the optical system, e.g., redirect light via reflection substantially without optical power, and effectively redirect the optical axis 122 in a different physical direction. In some examples, optical axis 122 may be defined by lens 106, and in other examples, optical axis 122 may be defined by another element of camera 100, e.g., another lens (not shown) or sensor 108, e.g., as an axis extending perpendicularly from the center of sensor 108.

In the example shown, first prism 102 is configured to rotate about first axis 112 and second prism 104 is configured to rotate about second axis 114. First axis 112 may be a “pitch” rotational axis and second axis 114 may be a “yaw” rotational axis. In the example shown, first and second prisms 102, 104 are separated from each other by a minimum distance, e.g., at least the physical length of lens 106. Although shown as positioned between first and second prisms 102, 104, lens 106 may be positioned before or after first and second prisms 102, 104, e.g., on the other side of first and second prisms 102, 104 from sensor 108 or between sensor 108 and first and second prisms 102, 104. In such examples, first and second prisms 102, 104 may be separated from each other by a length that is less than the physical length of lens 106, e.g., by a length that at least allows first and second prisms 102, 104 to independently rotate without contacting each other. In the example shown, second prism 104 is placed at ninety degrees with respect to first prism 102.

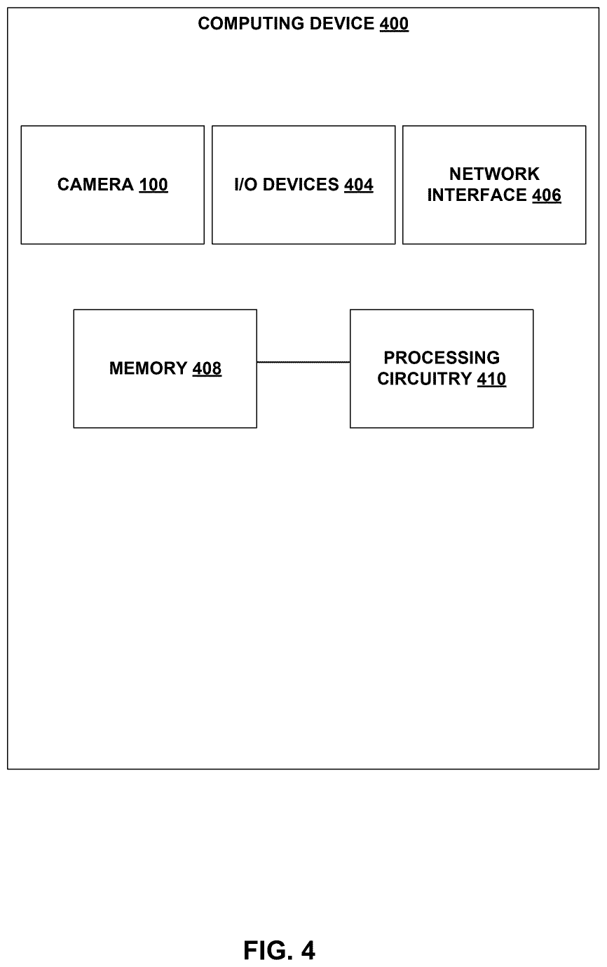

First actuator 142 may be configured to rotate first prism 102 about first axis 112 and second actuator 144 may be configured to rotate second prism 104 about second axis 114. For example, controller 110, or processing circuitry 410 (FIG. 4) may be configured to perform optical image stabilization (OIS) by independently controlling first actuator 142 to rotate first prism 102 about first axis 112 and controlling second actuator 144 to rotate second prism 104 about second axis 114. Controller 110 or processing circuitry 410 may send signals to first and second actuators 142, 144 to independently control first and second actuators 142, 144. In some examples, one or both of actuators 142, 144 may be magnet and coil actuators.

In some examples, second prism 104 is placed at ninety degrees with respect to first prism 102 to fold optical axis 122. For example, second prism 104 may be placed at ninety degrees with respect to first prism 102 to fold optical axis 122 to any direction in a plane substantially perpendicular to the direction of the optical axis between first prism 102 and second prism 104. In the example shown, second prism 104 is placed at ninety degrees with respect to first prism 102 to fold optical axis 122 from being parallel with the x-direction to being parallel with any direction in the y-z plane, e.g., the z-direction in the example shown.

In the example shown, first and second prisms 102, 104 are front surface reflecting prisms. For example, the first surface 132 of first prisms 102 and the first surface 134 of second prism 104 each reflect light and substantially no light enters first or second prisms 102, 104. In other examples, on or both of first and second prisms 102, 104 may be refracting prisms (not shown) in which light first enters first and/or second prisms 102, 104 and reflect off an inner surface of first and/or second prisms 102, 104, e.g., via total internal reflection (TIR).

First and second prisms 102, 104 and lens 106 may be made of glass, plastic, or any suitable material. For example, first and second prisms 102, 104 and lens 106 may be comprised of plastic material, such as a polycarbonate, a polyester, a polystyrene, an acrylic such as poly(methyl methacrylate) (PMMA), or any suitable polymer, an injection molded plastic material, or other transparent materials (e.g., glass), and may include one or more coatings (e.g., highly reflective coatings for first and second prisms 102, 104 and anti-reflection coatings for lens 106). In some examples, lens 106 may be an autofocus lens.

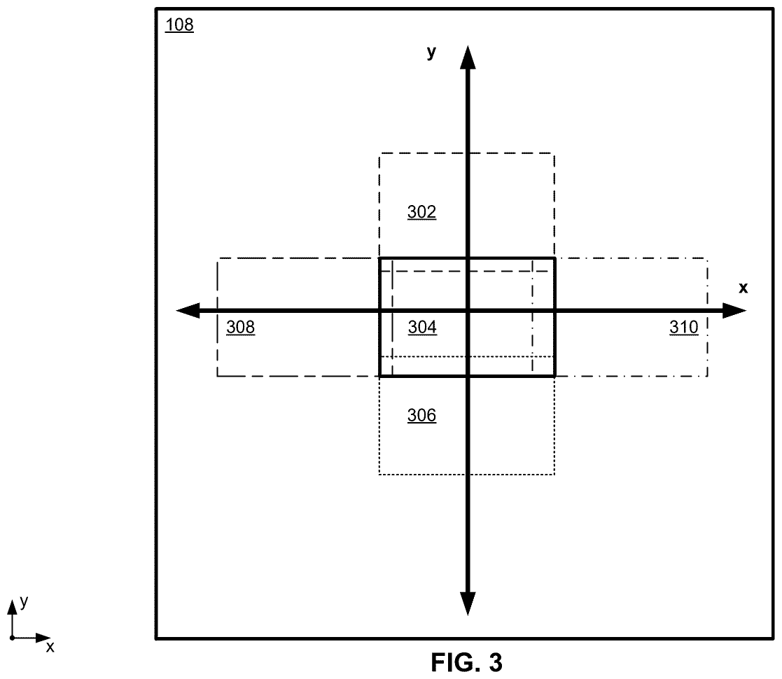

First prism 102 may be configured to scan an image in a first direction, and second prism 104 may be configured to scan the image in a second direction perpendicular to the first direction, and first and second prisms 102, 104 may be configured to scan the image without cross-talk between the first and second directions. In some examples, first and second prisms 102, 104 are configured to scan the image in first and second directions in the plane of sensor 108, e.g., the x-y plane in the example shown. For example, first actuator 142 may be configured to rotate first prism 102 about first axis 112, which may be a pitch axis along the z-direction in the example shown, in order to scan an image along a first direction, e.g., a y-direction, of sensor 108. Second actuator 144 may be configured to second prism 104 about second axis 114, which may be a yaw axis along the y-direction in the example shown, in order to scan an image along a second direction, e.g., an x-direction, of sensor 108, as shown in FIG. 3. Controller 110 may be configured to perform optical image stabilization (OIS) by independently controlling first actuator 142 to rotate first prism 102 about first axis 112 and controlling second actuator 144 to rotate second prism 104 about second axis 114. Controller 110 may include processing circuitry (e.g., one or more processors), such as processing circuitry 410 described below.

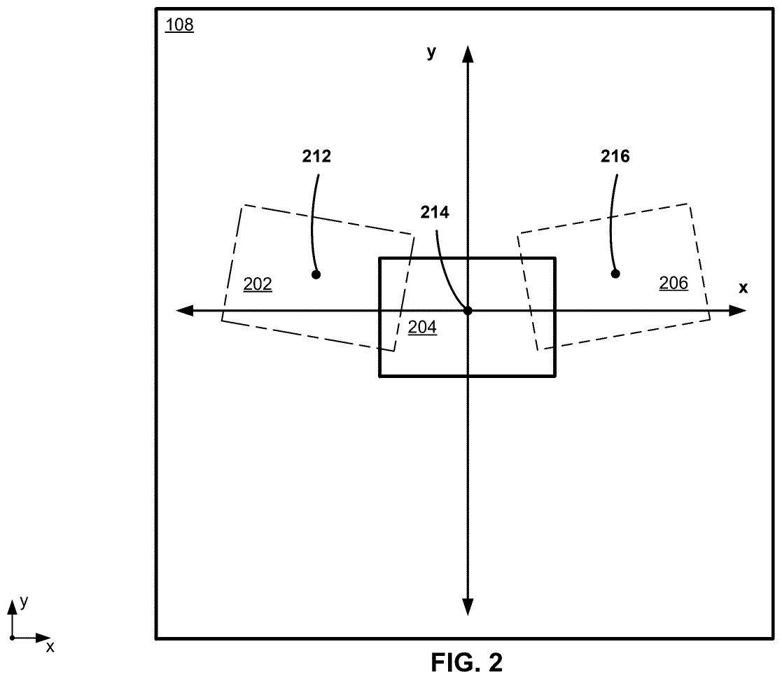

By way of contrast, FIG. 2 illustrates a set of example image positions 202-206 during an OIS scan illustrating cross-talk between the scan axes of a single prism OIS lens, e.g., a camera including a single prism configured to rotate about both axes 112, 114. In the example shown, such a single prism camera may be able to rotate a prism about pitch axis 112 to scan an image along the first, y-direction (not shown), but when the single prism rotates about yaw axis 114, the image moves in the second, x-direction and the first, y-direction. For example, at a first x-axis scan position, the single prism may be rotated to a yaw rotation position such that the image is at image position 204 having centroid position 214, e.g., at the center of sensor 108. The single prism may be rotated about yaw axis 114 to scan the image to a second x-axis position at image position 202, and then the single prism may be rotated about yaw axis 114 to scan the image to a third x-axis position at image position 206. Image positions 202 and 206 move the image in both the x-direction as intended, and the y-direction, as indicated by the centroid position 212 of image position 202 and the centroid position 216 of image position 206. The single prism having dual rotation axes is not able to scan the image just along the x-axis without changing the y-direction position of the image.

Additionally, during yaw rotation and x-direction scanning, the single prism may cause the image to rotate in the plane of sensor 108, e.g., the cross-talk between the x-y scanning directions due to rotating the single prism along the yaw axis 114 rotates the image, as indicated by the clockwise rotation of image position 202 and the counterclockwise rotation of image position 206 shown in FIG. 2.

FIG. 3, however, is a set of example image positions during an optical image stabilization (OIS) scan illustrating no cross-talk between the scan axes of a dual prism OIS lens, in accordance with one or more aspects of the present disclosure. In the example shown, sensor 108 defines a planar surface perpendicular to optical axis 122 of camera 100 (FIG. 1) and the first (y) and second (x) directions are parallel with the planar surface of the sensor 108. Referring to both FIGS. 1 and 3, in the examples shown, first prism 102 is configured to rotate about pitch axis 112 to scan an image in the first direction (the y-direction), e.g., to position the image at image positions 302, 304, or 306, without moving the image in the second (x) direction. In the examples shown, second prism 104 is configured to rotate about yaw axis 114 to scan the image in the second direction (the x-direction), e.g., to position the image at image positions 308, 304, or 310, without moving the image in the first (y) direction. In some examples, first and second prisms 102, 104 may both be rotated, e.g., to scan the image along a line at an angle with the first and second (e.g., x-y) directions. Additionally, first and second prisms 102, 104 are configured to scan the image without rotation of the image in the plane of sensor 108, e.g., in both scanning directions, independent of each other and without image rotation.

Returning to FIG. 1, in some examples, camera 100 may have a total track length (TTL) that is greater than a TTL of a camera including a single prism configured to rotate about perpendicular axes. For example, camera 100 including both first and second prisms 102, 104 may have an effective focal length (EFL) and a TTL that is greater than a camera having a single prism, e.g., corresponding to either prism 102 or 104, by virtue of adding an additional fold to optical axis 122 allowing for more positioning options for sensor 108.

FIG. 4 is an example computing system 400 that may be used with a camera 100, in accordance with one or more aspects of the present disclosure. Computing system 400 may implement methods for controlling operations of camera 100 and/or for performing OIS and/or image processing of images captured with the camera 100. In some examples, computing system 400 may be any of various types of devices, including, but not limited to, a personal computer system, desktop computer, laptop, notebook, tablet or pad device, slate, or netbook computer, mainframe computer system, handheld computer, workstation, network computer, a camera, a set top box, a mobile device, a wireless phone, a smartphone, a consumer device, video game console, handheld video game device, application server, storage device, a television, a video recording device, a peripheral device such as a switch, modem, router, or in general any type of computing or electronic device.

In the example shown, computing system 400 may include processing circuitry 410 (e.g., one or more processors) coupled to a memory 408. In some examples, processing circuitry 410 may be configured to function as controller 110 (FIG. 1) and may be configured to perform OIS by independently controlling first actuator 142 to rotate first prism 102 about first axis 112 and controlling second actuator 144 to rotate second prism 104 about second axis 114. In some examples, processing circuitry 410 may be included with controller 110, and in other examples, processing circuitry 410 may be communicatively coupled to controller 110 and configured to send and receive instructions and data to and from controller 110. Computing system 400 also may include a network interface 406, input/output devices 404, e.g., a cursor control device, mouse, touchpad, trackball, a keyboard, a display, or the like. Computing system 400 also may include one or more cameras 100 which may include a lens system including first and second prisms 102, 104.

Memory 408 may be configured to store program instructions and/or data accessible by processing circuitry 410. Memory 408 may be implemented using any suitable memory technology, such as static random access memory (SRAM), synchronous dynamic RAM (SDRAM), nonvolatile/flash-type memory, or any other type of memory. Program instructions may be configured to implement various interfaces, methods and/or data for controlling operations of camera 100 and for OIS or capturing and processing images with camera 100 or other methods or data, for example interfaces and methods for capturing, displaying, processing, and storing images captured with camera 100. In some examples, program instructions and/or data may be received, sent or stored upon different types of computer-accessible media or on similar media separate from system memory 408 or computing system 400.

Network interface 406 may be configured to allow data to be exchanged between computing system 400 and other devices attached to a network (e.g., carrier or agent devices) or between nodes of computing system 400. Network interface 406 may include one or more networks including but not limited to Local Area Networks (LANs) (e.g., an Ethernet or corporate network), Wide Area Networks (WANs) (e.g., the Internet), wireless data networks, some other electronic data network, or some combination thereof. Network interface 406 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 404 may include one or more display terminals, keyboards, keypads, touchpads, scanning devices, voice or optical recognition devices, or any other devices suitable for entering or accessing data by computing system 400. Multiple input/output devices 404 may be present in computing system 400 or may be distributed on various nodes of computing system 400. In some examples, similar input/output devices 404 may be separate from computing system 400 and may interact with one or more nodes of computing system 400 through a wired or wireless connection, such as over network interface 406.

In the example shown, memory 408 may include program instructions which may be processor-executable to implement any element or action to support camera 100, including but not limited to image processing software and interface software for controlling camera 100. In some examples, images captured by camera 100 may be stored to memory 408. In addition, metadata for images captured by camera 100 may be stored using memory 408.

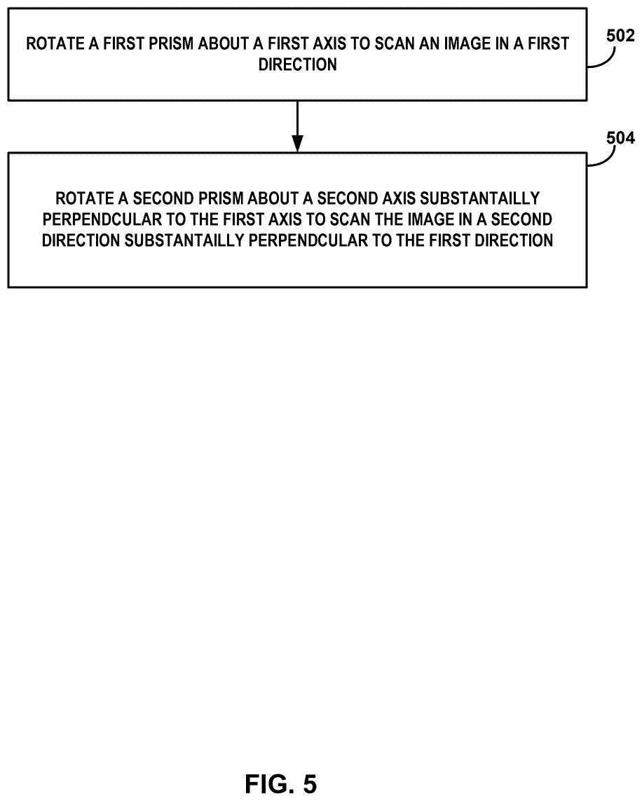

FIG. 5 is a flow chart of an example method of OIS using a dual prism lens, in accordance with one or more aspects of the present disclosure. Although the example method of FIG. 5 is described with respect to camera 100 of FIG. 1, the example technique of FIG. 5 may be performed using any device including separate prisms configured to independently rotate about perpendicular axes. FIG. 5 is described with reference to FIGS. 1, 3, and 4.

Processing circuitry 410 may cause actuator 142 to rotate first prism 102 about a first axis 112 to scan an image in a first direction (502). For example, processing circuitry 410 may cause an actuator (e.g., a magnet and coil actuator) to cause first prism 102 to rotate about pitch axis 112 to scan an image along the y-axis of sensor 108.

Processing circuitry 410 may cause camera 100 to rotate second prism 102 about a second axis 114 to scan an image in a second direction (504). For example, processing circuitry 410 may cause the same, or different, actuator (e.g., a magnet and coil actuator) to cause second prism 104 to rotate about yaw axis 114 to scan an image along the x-axis of sensor 108, e.g., without any cross-talk between the first and second directions.

In some examples, processing circuitry 410 may determine a first amount to scan the image in the first direction and a second amount to scan the image in the second direction independently of the first direction in order to stabilize the image on sensor 108 relative to a motion of the camera 100. Processing circuitry 410 may then cause the first prism 102 to rotate about the first axis 112 to scan the image by the first amount in the first (y) direction and the second prism 104 to rotate about the second axis 114 to scan the image by the second amount in the second (x) direction without cross-talk between the first and second directions.

Computing system 400 and devices described herein may include any combination of hardware or software that can perform the indicated functions, including computers, network devices, Internet appliances, PDAs, wireless phones, pagers, video or still cameras, and the like. Computing system 400 may also be connected to other devices that are not illustrated, or instead may operate as a stand-alone system. In addition, the functionality provided by the illustrated components may, in some examples, be combined in fewer components or distributed in additional components. Similarly, in some examples, the functionality of some of the illustrated components may not be provided and/or other additional functionality may be available.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, may include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

This disclosure includes the following examples:

Example 1: A camera includes: an image sensor; a lens configured to focus light to the image sensor; a first prism; a first actuator configured to rotate the first prism about a first axis; a second prism; a second actuator configured to rotate the second prism about a second axis substantially perpendicular to the first axis; and a controller configured to perform optical image stabilization (OIS) by independently controlling the first actuator to rotate the first prism about the first axis and controlling the second actuator to rotate the second prism about the second axis.

Example 2: The camera of example 1, wherein the first prism is separated from the second prism by a minimum distance.

Example 3: The camera of example 1 or example 2, wherein the first actuator is configured to control the first prism to scan an image in a first direction, wherein the second actuator is configured to control the second prism to scan the image in a second direction perpendicular to the first direction without cross-talk between the first and second directions.

Example 4: The camera of example 3, wherein the image sensor defines a planar surface perpendicular to an optical axis of the camera, wherein the first and second directions are parallel with the planar surface of the image sensor.

Example 5: The camera of any one of examples 1 through 4, wherein the lens is positioned between the first prism and the second prism.

Example 6: The camera of any one of examples 1 through 5, wherein the first and second prisms are configured to fold an optical axis of the camera.

Example 7: The camera of any one of examples 1 through 6, wherein a total track length (TTL) of the camera is greater than a TTL of a camera including a single prism configured to rotate about perpendicular axes.

Example 8: An optical system includes: a lens defining an optical axis; a first prism configured to rotate about a first axis; and a second prism configured to rotate about a second axis substantially perpendicular to the first axis.

Example 9: The optical system of example 8, wherein the first prism is separated from the second prism by a minimum distance.

Example 10: The optical system of example 8 or example 9, wherein the first prism is configured to scan an image in a first direction, wherein the second prism is configured to scan the image in a second direction perpendicular to the first direction, wherein the first and second images are configured to scan the image without cross-talk between the first and second directions.

Example 11: The optical system of example 10, wherein the first and second directions are each perpendicular to an optical axis of the optical system.

Example 12: The optical system of any one of examples 8 through 11, wherein the lens is positioned between the first prism and the second prism.

Example 14: The optical system of any one of examples 8 through 12, wherein a total track length (TTL) of the optical system is greater than a TTL of an optical system including a single prism configured to rotate about perpendicular axes.

Example 15: A method includes: capturing, by an image sensor, an image; performing optical image stabilization (OIS) by: rotating, by a first actuator, a first prism of a camera about a first axis to scan an image in a first direction; and rotating, by a second actuator, a second prism of the camera about a second axis substantially perpendicular to the first axis to scan the image in a second direction independently from and substantially perpendicular to the first direction.

Example 16: The method of example 15, wherein the first prism is separated from the second prism by a minimum distance.

Example 17: The method of example 15 or example 16, further includes determining, by processing circuitry and based on the image captured by the image sensor of the camera, a first amount to scan the image in the first direction and a second amount to scan the image in the second direction independently of the first direction in order to stabilize the image on the sensor relative to a motion of the camera; and rotating, by the first actuator, the first prism about the first axis to scan the image by the first amount in the first direction; and rotating, by the second actuator, the second prism about the second axis to scan the image by the second amount in the second direction without cross-talk between the first and second directions.

Example 18: The method of any one of examples 15 through 17, wherein a lens of the camera is positioned between the first prism and the second prism.

Example 19: The method of any one of examples 15 through 18, wherein the first prism folds an optical axis of the camera and the second prism folds the optical axis of the camera.

Various examples of the disclosure have been described. Any combination of the described systems, operations, or functions is contemplated. These and other examples are within the scope of the following claims.

1. A camera comprising:
an image sensor;
a lens configured to focus light to the image sensor;
a first prism;
a first actuator configured to rotate the first prism about a first axis;
a second prism;
a second actuator configured to rotate the second prism about a second axis substantially perpendicular to the first axis; and
a controller configured to perform optical image stabilization (OIS) by independently controlling the first actuator to rotate the first prism about the first axis and controlling the second actuator to rotate the second prism about the second axis.

2. The camera of claim 1, wherein the first prism is separated from the second prism by a minimum distance.

3. The camera of claim 1, wherein the first actuator is configured to control the first prism to scan an image in a first direction, wherein the second actuator is configured to control the second prism to scan the image in a second direction perpendicular to the first direction without cross-talk between the first and second directions.

4. The camera of claim 3, wherein the image sensor defines a planar surface perpendicular to an optical axis of the camera, wherein the first and second directions are parallel with the planar surface of the image sensor.

5. The camera of claim 1, wherein the lens is positioned between the first prism and the second prism.

6. The camera of claim 1, wherein the first and second prisms are configured to fold an optical axis of the camera.

7. The camera of claim 1, wherein a total track length (TTL) of the camera is greater than a TTL of a camera including a single prism configured to rotate about perpendicular axes.

8. An optical system comprising:
a lens defining an optical axis;
a first prism configured to rotate about a first axis; and
a second prism configured to rotate about a second axis substantially perpendicular to the first axis.

9. The optical system of claim 8, wherein the first prism is separated from the second prism by a minimum distance.

10. The optical system of claim 8, wherein the first prism is configured to scan an image in a first direction, wherein the second prism is configured to scan the image in a second direction perpendicular to the first direction, wherein the first and second images are configured to scan the image without cross-talk between the first and second directions.

11. The optical system of claim 10, wherein the first and second directions are each perpendicular to an optical axis of the optical system.

12. The optical system of claim 8, wherein the lens is positioned between the first prism and the second prism.

13. The optical system of claim 8, wherein the first and second prisms are configured to fold an optical axis of the optical system.

14. The optical system of claim 8, wherein a total track length (TTL) of the optical system is greater than a TTL of an optical system including a single prism configured to rotate about perpendicular axes.

15. A method comprising:
capturing, by an image sensor, an image;
performing optical image stabilization (OIS) by:
rotating, by a first actuator, a first prism of a camera about a first axis to scan an image in a first direction; and
rotating, by a second actuator, a second prism of the camera about a second axis substantially perpendicular to the first axis to scan the image in a second direction independently from and substantially perpendicular to the first direction.

16. The method of claim 15, wherein the first prism is separated from the second prism by a minimum distance.

17. The method of claim 15, further comprising:
determining, by processing circuitry and based on the image captured by the image sensor of the camera, a first amount to scan the image in the first direction and a second amount to scan the image in the second direction independently of the first direction in order to stabilize the image on the sensor relative to a motion of the camera; and
rotating, by the first actuator, the first prism about the first axis to scan the image by the first amount in the first direction; and
rotating, by the second actuator, the second prism about the second axis to scan the image by the second amount in the second direction without cross-talk between the first and second directions.

18. The method of claim 15, wherein a lens of the camera is positioned between the first prism and the second prism.

19. The method of claim 15, wherein the first prism folds an optical axis of the camera and the second prism folds the optical axis of the camera.
